(19) United States
(12) Patent Application Publication
(10) Pub. No.: US 2023/0351191 A1
(43) Pub. Date: Nov. 2, 2023

(54) INFORMATION PROCESSING APPARATUS, INFORMATION PROCESSING METHOD, COMPUTER PROGRAM, AND LEARNING SYSTEM

(71) Applicant: SONY GROUP CORPORATION, TOKYO (JP)

(72) Inventor: MASATO ISHII, TOKYO (JP)

(21) Appl. No.: 18/246,205

(22) PCT Filed: Aug. 18, 2021
(86) PCT No.: PCT/JP2021/030191

§ 371 Date: Mar. 22, 2023

(30) Foreign Application Priority Data
Oct. 13, 2020 (JP) 2020-172583

(51) Int. Cl. G06N 3/084

(52) U.S. Cl. CPC G06N 3/084

(57) ABSTRACT

The information processing apparatus includes: a management unit that stores a correspondence relationship between a training method for a model and task information of the model; and a selection unit that selects an optimum training method for task information input from a predetermined device and outputs the optimum training method to the device. The management unit associates pieces of specification information necessary for implementing training methods with the training methods, respectively, and stores the pieces of specification information and the training methods. The selection unit selects an optimum training method within a range of a specification available for training in the device.

### TECHNICAL FIELD

The technology disclosed in the present Description (hereinafter, “the present disclosure”) relates to an information processing apparatus, an information processing method, a computer program, and a learning system that perform processing for training a model.

### BACKGROUND ART

Artificial intelligence can analyze and estimate enormous data, and is utilized for, for example, image recognition, speech recognition, and natural language processing. Furthermore, artificial intelligence can control an object to be controlled such as a robot or an automobile, and execute various tasks in place of a human.

Artificial intelligence includes a model using a neural network or the like. Then, the use of artificial intelligence includes a “training phase” in which a model including a neural network or the like is trained and an “inference phase” in which inference is performed by using the model. In the training phase, a data set including a combination of data (hereinafter also referred to as “input data”) input to the model and a label desired to be estimated by the model for the input data is used to train the model by using a learning algorithm such as backpropagation so that a label corresponding to each piece of input data can be output. Then, in the inference phase, the model (hereinafter also referred to as a “trained model”) trained in the training phase outputs an appropriate label for the input data.

Generally, in order to train a more accurate model, it is preferable to perform deep learning or the like by using an enormous amount of training data sets, and a large-scale operation resource is required. Therefore, a development style is often adopted in which a model is trained by using a server, distributed learning, or the like, and the trained model obtained as an achievement of the training phase is mounted on an edge device.

In order to train a more accurate model, it is preferable to perform deep learning or the like by using an enormous amount of training data sets, and a large-scale operation resource is required. Therefore, a development style is often adopted in which a model is trained by using a server, distributed learning, or the like, and the trained model obtained as an achievement of the training phase is mounted on an edge device.

Furthermore, in order to realize high-performance or high-accuracy model training, training data corresponding to a task is indispensable. For example, there has been proposed a medical information system that specifies training data including medical images in which at least one of an imaging condition or a subject condition is different and an imaging direction is identical as a set among acquired medical images and solves a shortage of training data regarding medical images (see Patent Document 1).

### CITATION LIST

### Patent Document

Patent Document 1: Japanese Patent Application Laid-Open No. 2019-267900

### Non-Patent Document

Non-patent Document 1: “Multimodal Model-Agnostic Meta-Learning via Task-Aware Modulation”[NeurIPS2019]

### SUMMARY OF THE INVENTION

### Problems to be Solved by the Invention

An object of the present disclosure is to provide an information processing apparatus, an information processing method, a computer program, and a learning system that perform processing for efficiently training a model that performs a specific task.

### Solution to Problems

The present disclosure has been made in view of the above-described problems, and a first aspect thereof is an information processing apparatus including:
a management unit that stores a correspondence relationship between a training method for a model and task information of the model; and
a selection unit that selects an optimum training method for task information input from a predetermined device and outputs the optimum training method to the device.

The management unit may associate pieces of specification information necessary for implementing training methods with the training methods, respectively, and store the pieces of specification information and the training methods. In this case, the selection unit can select an optimum training method within a range of a specification available for training in the device.

Furthermore, a second aspect of the present disclosure is an information processing method including:
a management step of managing a correspondence relationship between a training method for a model and task information of the model in a database; and
a selection step of selecting, from the database, an optimum training method for task information input from a predetermined device and outputs the optimum training method to the device.

Furthermore, a third aspect of the present disclosure is a computer program described in a computer-readable format causing a computer to function as:
a management unit that stores a correspondence relationship between a training method for a model and task information of the model; and
a selection unit that selects an optimum training method for task information input from a predetermined device and outputs the optimum training method to the device.

The computer program according to the third aspect of the present disclosure defines a computer program described in a computer-readable format so as to realize predetermined processing on a computer. In other words, by installing the computer program according to the third aspect of the present disclosure in a computer, a cooperative action is exerted on the computer, and it is possible to obtain action and effect similar to those of the information processing apparatus according to the first aspect of the present disclosure.

Furthermore, a fourth aspect of the present disclosure is an information processing apparatus including:
a collection unit that collects a data set used for training a model;
an extraction unit that extracts task information of the model on the basis of the data set that has been collected;
an acquisition unit that acquires an optimum training method for the task information from an external apparatus; and
a training unit that trains the model by using the training method that has been acquired. The information processing apparatus according to the fourth aspect may further include an inference unit that performs inference by using a model trained by the training unit.

The extraction unit calculates a feature vector representing a data set that has been collected as task information by using meta-learning. Then, the acquisition unit acquires an optimum training method selected on the basis of task information having a similar feature vector.

The information processing apparatus according to the fourth aspect may further include a specification information calculation unit that calculates a specification available for training the model by the training unit. In this case, the acquisition unit can acquire an optimum training method for the task information, the optimum training method being able to be implemented within a range of the specification available.

Furthermore, a fifth aspect of the present disclosure is an information processing method including:
a collection step of collecting a data set used for training a model;
an extraction step of extracting task information of the model on the basis of the data set that has been collected;
an acquisition step of acquiring an optimum training method for the task information from an external apparatus; and
a training step of training the model by using the training method that has been acquired.

Furthermore, a sixth aspect of the present disclosure is a computer program described in a computer-readable format causing a computer to function as:
a collection unit that collects a data set used for training a model;
an extraction unit that extracts task information of the model on the basis of the data set that has been collected;
an acquisition unit that acquires an optimum training method for the task information from an external apparatus; and
a training unit that trains the model by using the training method that has been acquired.

Furthermore, a seventh aspect of the present disclosure is a learning system including:
a first apparatus that collects a data set and trains a model;
a second apparatus that outputs a training method for the model to the first apparatus;
in which the first apparatus extracts task information of the model on the basis of the data set that has been collected, and
the second apparatus selects an optimum training method for the task information of the first apparatus by using a database that stores a correspondence relationship between a training method for a model and task information of the model, and outputs the optimum training method to the first apparatus.

However, the term “system” as used herein refers to a logical assembly of a plurality of apparatuses (or functional modules that realizes specific functions), and it does not matter whether or not each apparatus or each functional module is in a single housing.

### Effects of the Invention

According to the present disclosure, an information processing apparatus, an information processing method, a computer program, and a learning system that perform processing for efficiently training a model that performs a specific task can be provided.

Note that the effects described in the present Description are merely examples, and the effects brought by the present disclosure are not limited thereto. Furthermore, the present disclosure further provides additional effects in addition to the effects described above in some cases.

Still other objects, features, and advantages of the present disclosure will become apparent from a more detailed description based on embodiments to be described later and the accompanying drawings.

### BRIEF DESCRIPTION OF DRAWINGS

FIG. 1 is a diagram illustrating a functional configuration example of a learning system 100.

FIG. 2 is a diagram illustrating an example of a data structure in a training method database 122.

FIG. 3 is a diagram illustrating a functional configuration example of a learning system 300.

FIG. 4 is a diagram illustrating an example of a data structure in the training method database 122.

FIG. 5 is a diagram illustrating a functional configuration example of a learning system 500.

FIG. 6 is a diagram illustrating a functional configuration example of a learning system 600.

FIG. 7 is a flowchart illustrating a processing procedure for an edge device to perform model training.

FIG. 8 is a diagram illustrating a configuration example of an information processing apparatus 800.

FIG. 9 is a diagram illustrating a mechanism in which a learner 901 trains a model 900 to be trained.

FIG. 10 is a diagram illustrating a mechanism in which a meta-learner 1001 learns an efficient training method for a model by the learner 1000.

### MODE FOR CARRYING OUT THE INVENTION

Hereinafter, the present disclosure will be described in the following order with reference to the drawings.

A. Overview

B. About meta-learning

C. System configuration

D. Cooperation between edge devices

E. Apparatus configuration

### A. Overview

Artificial intelligence includes, for example, a model using a type such as a neural network, support vector regression, or Gaussian process regression. In the present Description, for convenience, a neural network type model will be mainly described; however, the present disclosure is not limited to a specific model type, and can be similarly applied to models other than the neural network model. Use of artificial intelligence includes a “training phase” in which a model is trained and an “inference phase” in which inference is performed by using the trained model. Inference includes recognition processing such as image recognition or speech recognition, and prediction processing for estimating or predicting an event.

When certain data is input to a model, the model outputs an appropriate label. For example, the model of an image recognizer outputs a label representing a subject or an object in the input image. In the training phase, a training data set including a combination of input data and an appropriate (or the ground-truth) label is used to optimize a variable element (hereinafter also referred to as a “model parameter”) that defines a model so that a correct label for the input data can be input. Then, in the inference phase, unknown data is input and the corresponding label is inferred by using the model (hereinafter also referred to as a “trained model”) in which the model parameter optimized in the training phase is set.

In order to train a more accurate model (that is, in order for the trained model to be able to output an accurate label for unknown data), it is preferable to perform deep learning or the like by using an enormous amount of training data sets, and a large-scale operation resource is required. Therefore, a development style is often adopted in which a model is trained by using a server, distributed learning, or the like, and the trained model obtained as an achievement of the training phase is mounted on an edge device.

In contrast, it is necessary to use a data set collected by an edge device for training a model that performs a task specific to each edge device. However, there is a case where a data set cannot be taken out of an edge device due to an ethical or right issue, and in such a case, it is desirable to train a model by the edge device.

Furthermore, processing of learning a model training method, that is, meta-learning is known. By using meta-learning, it is possible to select an optimum training method according to the task, and it is possible to improve model training efficiency according to the task. However, optimization of the training method is processing with a very large calculation cost. Therefore, it is difficult to optimize training of a model that performs a task specific to the needs of each user on an edge device.

Therefore, the present disclosure proposes a technology that enables optimization of training of a model that performs a task specific to each edge device by using a data set collected by the edge device. More specifically, the present disclosure extracts task information regarding a data set collected by an edge device, and selects an optimum training method on the server side on the basis of the task information. Although optimization of the training method is processing with a very large calculation cost, such processing can be realized on the server side. Furthermore, the edge device can use the optimum training method selected on the server side to efficiently train a model that performs a task specific to each edge device by using the data set collected by the edge device.

Furthermore, there is a problem that the specification required for model training processing differs for each training method. Therefore, there is a possibility that a situation occurs in which the optimum training method selected on the basis of the task information on the server side cannot be adopted for model training on the edge device side since the optimum training method requires a higher specification than that of the edge device. Therefore, in the present disclosure, when the optimum training method is selected on the server side on the basis of the task information extracted from the data set collected by an edge device, the specification information available for model training on the edge device side is considered. Therefore, the edge device can use the optimum training method that can be implemented without exceeding its own specification to efficiently train a model that performs a task specific to each edge device by using the data set collected by the edge device.

Note that the task specific to each edge device is, for example, processing of recognizing a specific object on a chip attached to an image sensor. Specifically, each of the following (1) to (3) corresponds to a task specific to each edge device.

(1) The place and the attitude in which a specific part or an apparatus is disposed are recognized by a camera installed in a factory.

(2) An abnormality of a specific target is detected by a monitoring camera installed in a place with high confidentiality.

(3) Image recognition and speech recognition of a specific person are performed by a camera and a microphone mounted on a game console.

Furthermore, examples of the specifications available for model training on the edge device side include memory capacity, operation performance, operation time, power, and the like that can be used for model training on the edge device (for example, a chip attached to an image sensor). For example, in the examples (1) to (3) of the task described above, the specification available for model training on the edge device side may be estimated on the assumption of nighttime when a factory or a game console is not in operation.

### B. About Meta-Learning

In the present embodiment, in order to improve the efficiency of training of a model that performs a specific task on the edge device side, an optimum training method is selected on the server side by using meta-learning. Meta-learning is processing of learning a model training method, and generally, meta-learning is used to improve training efficiency of a model according to a task.

In a backpropagation method, which is one of training methods, a model parameter is determined so that a loss function defined on the basis of an error between output data of a model when data is input and labeled training data for the input data is minimized. Then, in order to reduce the loss function, a method such as gradient descent of calculating an inclination (gradient) of the loss function to be minimized and adjusting the model parameter in a direction opposite to the magnitude of the inclination is used. In meta-learning, as a model training method, for example, an initial model parameter to be used for training, a hyperparameter (the number of layers of the neural network, the number of units, a regularization factor, or the like) to be used for training, another model B that teaches “how to update a model A” during training, and the like are output. Meta-learning also includes a model such as a neural network, support vector regression, or Gaussian process regression.

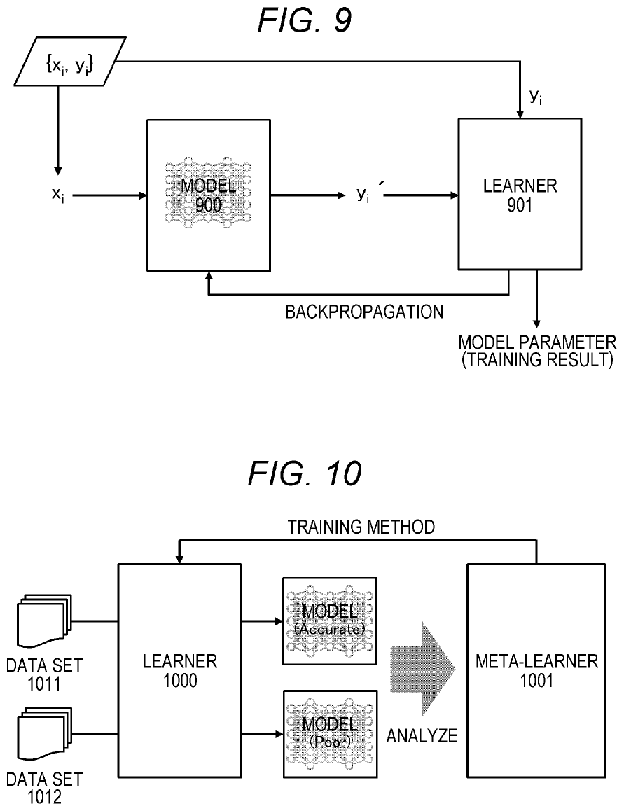

FIG. 9 illustrates a mechanism in which a learner 901 trains a model 900 to be trained. The model 900 includes, for example, a neural network. The learner trains the model 900 by using a data set {xᵢ, yᵢ}i=1^{N} including a set of input data xᵢ and a corresponding label yᵢ (that is, labeled training data). It is assumed that the model 900 outputs a label yᵢ′ when the data xᵢ is input. The learner 901 calculates a loss function L(E) based on an error E (=yᵢ−yᵢ′) between the ground-truth label yᵢ and the output label yᵢ′ of the model 900. Then, the learner 901 adjusts a model parameter Pm of the model 900 so as to minimize the loss function L(E).

FIG. 10 illustrates a mechanism in which a meta-learner 1001 analyzes model training by the learner 1000 and learns an efficient training method on the basis of the analysis result. As described above, the learner 1000 trains the model by using a learning algorithm based on the backpropagation method and gradient descent by using data sets. The meta-learner 1001 analyzes the training method of the learner 1000 on the basis of the quality (recognition rate or the like) of the model (recognizer) trained by the learner 1000 using each data set. For example, the meta-learner 1001 analyzes the training result indicating that the model trained by using a data set 1011 is of high quality (for example, the recognition rate is high (Accurate)) and the model trained by using a data set 1012 is of low quality (for example, the recognition rate is insufficient (poor)), and outputs information regarding an optimum training method such as an initial model parameter, a hyperparameter, another model B that teaches “how to update the model A” during training, and the like to the learner 1000.

Some meta-learning algorithms output not an optimum training method but a means for obtaining an optimum training method according to the data set (see, for example, Non Patent Document 1). In such an algorithm, the meta-learner 1001 performs processing of extracting a feature vector representing a data set by using the data set as an input and calculating an optimum training method on the basis of the feature vector.

### C. System Configuration

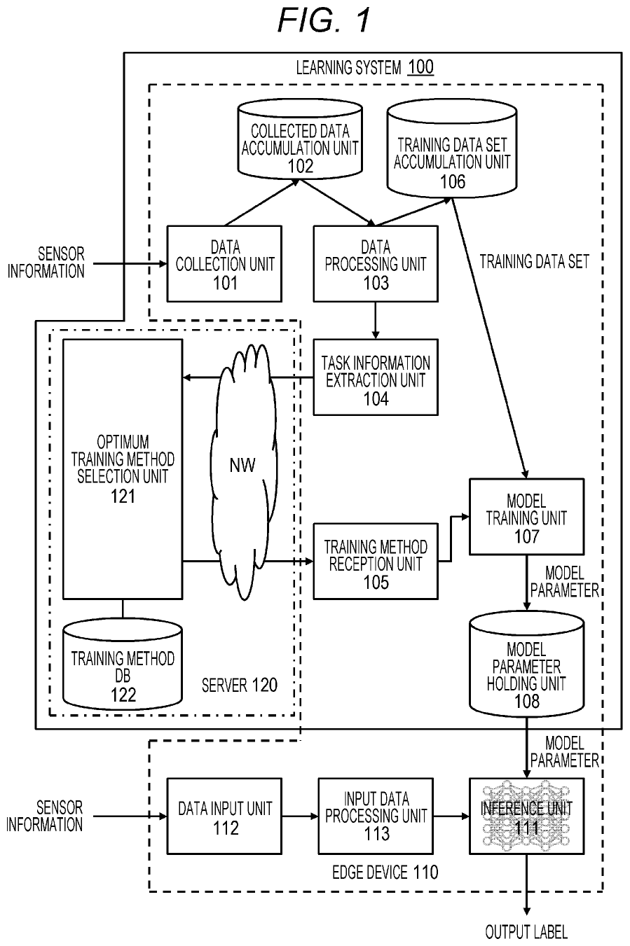

FIG. 1 illustrates a functional configuration example of a learning system 100 that optimizes training of a model that performs a task specific to each edge device by applying the present disclosure. The learning system 100 basically includes an edge device 110 and a server 120. In FIG. 1, the constituent elements of the edge device 110 are surrounded by a dotted line, and the constituent elements of the server 120 are surrounded by an alternate long and short dash line.

On the edge device 110 side, a data set collected by the edge device 110 itself is used to train a model that performs a task specific to the edge device 110 itself. Furthermore, the server 120 selects an optimum training method according to the task performed by the edge device 110. Here, there is a restriction that the data set collected by the edge device 110 cannot be taken out due to an ethical or right issue. Therefore, the edge device 110 extracts task information from the data set collected by itself and transmits the task information to the server 120. On the server 120 side, the optimum training method for the task specific to the edge device 110 is selected on the basis of the task information, and the edge device 110 is notified of the optimum training method. Therefore, the edge device 110 can efficiently train the model that performs the specific task by using the training method which the edge device 110 is notified of by the server 120.

Note that the server 120 can also select an optimum training method for a model that performs a general-purpose task as well as a task specific to each edge device. Furthermore, it is assumed that the edge device 110 mainly uses a neural network type model, but of course, a model of another type such as support vector regression or Gaussian process regression may be used.

The edge device 110 includes a data collection unit 101, a collected data holding unit 102, a task information extraction unit 104, a training method reception unit 105, a training data set accumulation unit 106, a model training unit 107, a model parameter holding unit 108, an inference unit 111, an input data processing unit 113, and a data input unit 112.

The data collection unit 101 collects data used for model training. Here, it is assumed that the data collection unit 101 collects sensor information acquired by a sensor (not illustrated) included in the edge device 110. The sensor included in the edge device 110 is, for example, a camera, an infrared camera, or an audio sensor such as a microphone, and the sensor information is an image captured by the camera, input audio data, or the like. The collected data accumulation unit 102 temporarily stores data collected by the data collection unit 101.

The data processing unit 103 reads the data stored in the collected data accumulation unit 102, performs data processing so as to obtain a data format that can be input to a model (neural network or the like) to be trained, and further assigns an appropriate (or ground-truth) label to the data to generate a training data set, and stores the training data set in the training data set accumulation unit 106.

The task information extraction unit 104 extracts information of the task performed by the edge device 110 on the basis of the data set generated by the data processing unit 103 from the data collected by the data collection unit 101, and sends the information to the server 120 via a network (NW). The task performed by the edge device 110 is processing in which the inference unit 111 performs inference on the input data by using the model parameter learned by the model training unit 107. Furthermore, the task information extraction unit 104 extracts a feature vector representing a data set as task information by using meta-learning.

As will be described later, on the server 120 side, an optimum training method on the edge device 110 side is selected on the basis of the task information received from the edge device 110, and the selected training method is sent to the edge device 110 via the network (NW). The training method reception unit 105 receives the optimum training method from the server 120. The optimum training method includes at least one of, for example, an initial model parameter to be used for training, a hyperparameter (the number of layers of the neural network, the number of units, a regularization factor, or the like) to be used for training, another model B that teaches “how to update a model A” during training, or the like.

The model training unit 107 sequentially reads a data set from the training data set accumulation unit 105 and trains a model such as a neural network. As will be described later, on the server 120 side, an optimum training method for a model that performs a task specific to the edge device 110 side is selected on the basis of the task information received from the edge device 110, and is sent to the edge device 110 via the network (NW). Therefore, the model training unit 107 can efficiently train a model that performs a task specific to the edge device 110 by using the training method received by the training method reception unit 105 from the server 120.

Then, the model training unit 107 stores the model parameter obtained as the training result in the model parameter holding unit 108. The model parameter is a variable element that defines a model, and is, for example, a factor or a weighting factor given to each neuron of a neural network model.

The inference unit 111, the data input unit 112, and the input data processing unit 113 implement the inference phase of the model on the basis of the training result by the model training unit 107. The data input unit 112 inputs sensor information acquired by the sensor included in the edge device 110. The input data processing unit 113 performs data processing on the data input from the data input unit 112 so as to obtain a data format that can be input to a model (for example, a neural network model), and inputs the data to the inference unit 111. The inference unit 111 outputs a label inferred from the input data by using the model in which the model parameter read from the model parameter holding unit 108 is set, that is, the trained model.

The server 120 includes an optimum training method selection unit 121 and a training method database (DB) 122. The training method database 122 stores information of an optimum combination of a training method and task information. When the optimum training method selection unit 121 receives task information from the edge device 110 by using information stored in the training method database 122, the optimum training method selection unit 121 searches for the most similar task information stored in the training method database 122, determines that the training method corresponding to the applicable task information is optimal for the task specific to the edge device 110, and sends the training method to the edge device 110.

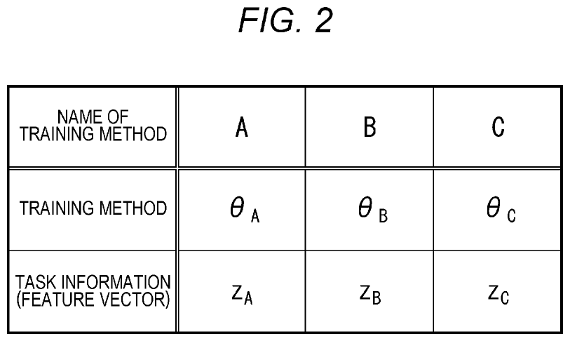

FIG. 2 illustrates an example of a data structure in the training method database 122. In the example illustrated in FIG. 2, three types of training methods A to C and pieces of task information to which the training methods are optimally applied, respectively are stored. The training method includes at least one of, for example, an initial model parameter to be used for training, a hyperparameter (the number of layers of the neural network, the number of units, a regularization factor, or the like) to be used for training, another model B that teaches “how to update a model A” during training, or the like. Furthermore, the task information is a feature vector calculated by using meta-learning from a large number of data sets for training using the relevant training method. In FIG. 2, a feature vector of the task information corresponding to a training method θ_{A} is denoted by z_{A}, a feature vector of the task information corresponding to a training method θ_{B} is denoted by z_{B}, and a feature vector of the task information corresponding to a training method θ_{C} is denoted by z_{C}. It is assumed that an optimum training method is acquired for each task information on the basis of a meta-learning framework.

The optimum training method selection unit 121 calculates similarity between task information received from the edge device 110 and the task information of each training method stored in the training method database 122. There are various measures for measuring similarity between pieces of task information. As described above, the task information includes a feature vector calculated from a data set by using meta-learning. Therefore, the optimum training method selection unit 121 may express similarity between pieces of task information by using the inner product of the feature vectors of the respective pieces of task information. For example, assuming that the feature vector of a data set I received from the edge device 110 is z_{I} and the feature vector of the task information corresponding to a j-th training method is zⱼ, similarity between the input data set and a j-th reference data set group is expressed by z_{I}^{T}zⱼ. Then, the optimum training method selection unit 121 determines the training method θⱼ having the most similar task information to that of the edge device 110 according to the following Expression (1) and sends the training method θⱼ to the edge device 110 side. Alternatively, the optimum training method selection unit 121 may express similarity between the data sets by using a negative Euclidean distance between the vectors of the feature vectors of the respective data sets.

$$\begin{matrix}[ Mathematical Expression 1 ] & \\ arg {min}_{j} {z}_{I}^{T} {z}_{j} & ( 1 )\end{matrix}$$

Note that, although the server 120 and the edge device 110 correspond on a one-to-one basis in the example illustrated in FIG. 1, it should be understood that the learning system 100 is actually configured such that one server provides the same service to a plurality of edge devices.

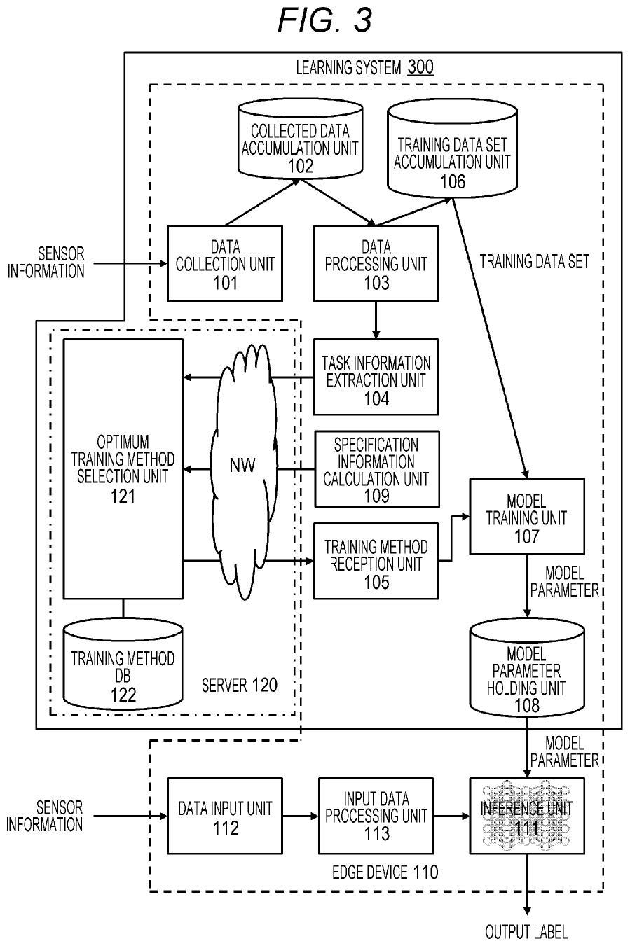

FIG. 3 illustrates another functional configuration example of a learning system 300 that optimizes training of a model which performs a task specific to each edge device by applying the present disclosure. The learning system 300 basically includes an edge device 110 and a server 120. In FIG. 3, the constituent elements of the edge device 110 are surrounded by a dotted line, and the constituent elements of the server 120 are surrounded by an alternate long and short dash line. However, among the constituent elements illustrated in FIG. 3, constituent elements given the same names and the same reference signs in FIG. 1 are basically the same constituent elements.

The edge device 110 extracts task information from a data set collected by itself and transmits the task information to the server 120 together with specification information available for model training. On the server 120 side, the optimum training method for the task specific to the edge device 110 is selected within the range of the available specification information, and the edge device 110 is notified of the optimum training method. Therefore, the edge device 110 can use the optimum training method that can be implemented without exceeding its own specification to efficiently train a model that performs a task specific to each edge device by using the data set collected by the edge device.

Note that the server 120 can also select an optimum training method for a model that performs a general-purpose task as well as a task specific to each edge device within the range of specification information available for the edge device. Furthermore, it is assumed that the edge device 110 mainly uses a neural network type model, but of course, a model of another type such as support vector regression or Gaussian process regression may be used.

The edge device 110 includes a data collection unit 101, a collected data holding unit 102, a task information extraction unit 104, a training method reception unit 105, a training data set accumulation unit 106, a model training unit 107, a model parameter holding unit 108, a specification information calculation unit 109, an inference unit 111, an input data processing unit 113, and a data input unit 112.

The data collection unit 101 collects sensor information acquired by a sensor (not illustrated) included in the edge device 110 as data used for model training. Then, the collected data accumulation unit 102 temporarily stores data collected by the data collection unit 101.

The data processing unit 103 reads the data stored in the collected data accumulation unit 102, performs data processing so as to obtain a data format that can be input to a model (neural network or the like) to be trained, and further assigns an appropriate label to the data to generate a training data set, and stores the training data set in the training data set accumulation unit 106.

The task information extraction unit 104 extracts information of the task performed by the edge device 110 on the basis of the data set generated by the data processing unit 103 from the data collected by the data collection unit 101, and sends the information to the server 120 via a network (NW). The task information extraction unit 104 extracts a feature vector representing a data set as task information by using meta-learning.

The specification information calculation unit 109 calculates a specification that can be used for model training by the edge device 110. Examples of the specification available for model training include memory capacity, operation performance, operation time, power, and the like that can be used for model training. For example, the specification information calculation unit 109 may estimate the specification that can be used for model training by the edge device 110 on the assumption of a time when the edge device 110 is not in operation, such as nighttime. Then, the specification information calculation unit 109 sends the calculated specification information to the server 120 via a network (NW). Note that the specification information calculation unit 109 may include a memory that stores specification information calculated in advance, instead of calculating the specification that can be used for model training, and may send the specification information to the server 120 as necessary.

As will be described later, on the server 120 side, an optimum training method within the range of the specification information available for the edge device 110 side is selected on the basis of the task information and the specification information received from the edge device 110, and the optimum training method is sent to the edge device 110 via the network (NW). The training method reception unit 105 receives the optimum training method from the server 120. The optimum training method includes at least one of, for example, an initial model parameter to be used for training, a hyperparameter (the number of layers of the neural network, the number of units, a regularization factor, or the like) to be used for training, another model B that teaches “how to update a model A” during training, or the like.

The model training unit 107 sequentially reads a data set from the training data set accumulation unit 105 and trains a model such as a neural network. As will be described later, on the server 120 side, an optimum training method for the model that performs a task specific to the edge device 110 side is selected within the range of the specification information available on the edge device 110 on the basis of the task information and the specification information received from the edge device 110, and the optimum training method is sent to the edge device 110 via the network (NW). Therefore, the model training unit 107 can efficiently train the model that performs a task specific to the edge device 110 within the range of the available specification information by using the training method received by the training method reception unit 105 from the server 120.

Then, the model training unit 107 stores the model parameter obtained as the training result in the model parameter holding unit 108. The model parameter is a variable element that defines a model, and is, for example, a factor or a weighting factor given to each neuron of a neural network model.

The inference unit 111, the data input unit 112, and the input data processing unit 113 implement the inference phase of the model on the basis of the training result by the model training unit 107. The data input unit 112 inputs sensor information acquired by the sensor included in the edge device 110. The input data processing unit 113 performs data processing on the data input from the data input unit 112 so as to obtain a data format that can be input to a model (for example, a neural network model), and inputs the data to the inference unit 111. The inference unit 111 outputs a label inferred from the input data by using the model in which the model parameter read from the model parameter holding unit 108 is set, that is, the trained model.

The server 120 includes an optimum training method selection unit 121 and a training method database (DB) 122. The training method database 122 stores combinations of optimum task information corresponding to each training method and specification information necessary for the training method. When the optimum training method selection unit 121 receives task information and specification information from the edge device 110 by using information stored in the training method database 122, the optimum training method selection unit 121 searches for the most similar task information stored in the training method database 122 within the range allowed by the specification information that has been received, determines that the training method corresponding to the applicable task information is optimal for the task specific to the edge device 110, and sends the training method to the edge device 110.

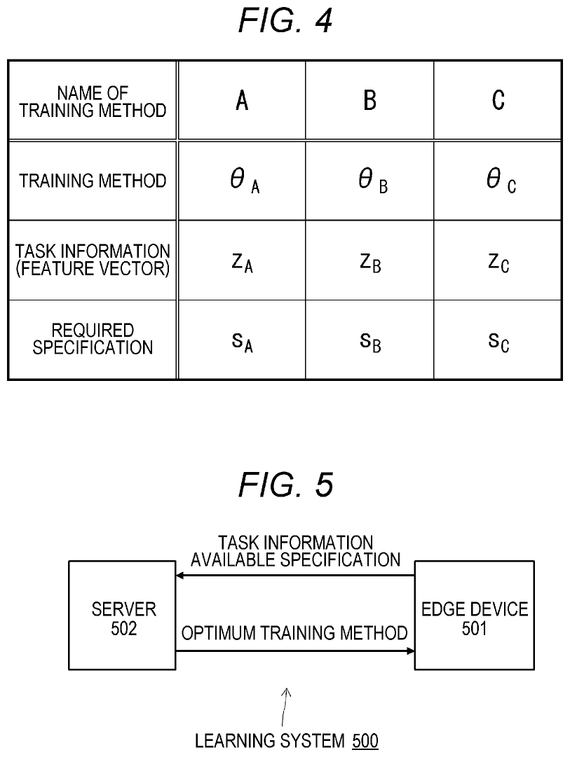

FIG. 4 illustrates an example of a data structure in the training method database 122. In the example illustrated in FIG. 4, three types of training methods A to C, task information to which the training methods are optimally applied, respectively, and pieces of specification information necessary for implementing the training methods, respectively, are stored. The training method includes at least one of, for example, an initial model parameter to be used for training, a hyperparameter (the number of layers of the neural network, the number of units, a regularization factor, or the like) to be used for training, another model B that teaches “how to update a model A” during training, or the like. Furthermore, the task information is a feature vector calculated by using meta-learning from a large number of data sets for training using the relevant training method. Furthermore, examples of specification information include memory capacity, operation performance, operation time, power, and the like that can be used for model training. In FIG. 4, it is assumed that a feature vector of task information corresponding to a training method θ_{A} is z_{A}, specification information necessary for implementing the training method θ_{A} is s_{A}, a feature vector of the task information corresponding to a training method θ_{B} is z_{B}, specification information necessary for implementing the training method θ_{B} is s_{B}, a feature vector of the task information corresponding to a training method θ_{C} is z_{C}, and specification information necessary for implementing the training method θ_{C} is s_{C}. It is assumed that an optimum training method according to the specification is acquired for each task information on the basis of a meta-learning framework.

The optimum training method selection unit 121 calculates the similarity between the task information received from the edge device 110 and the task information of each training method stored in the training method database 122, and compares the specification information necessary for each training method with the specification information available for the edge device 110. There are various measures for measuring similarity between pieces of task information. As described above, the task information includes a feature vector calculated from a data set by using meta-learning. Therefore, the optimum training method selection unit 121 may express similarity between pieces of task information by using the inner product of the feature vectors of the respective pieces of task information. For example, assuming that the feature vector of the data set I received from the edge device 110 is z_{I}, the specification information available for the edge device 110 is s_{I}, the feature vector of the task information corresponding to the j-th training method is zⱼ, and the specification information necessary for the j-th training method is sj, similarity between the input data set and a j-th reference data set group is expressed by z_{I}^{T}zⱼ. Then, according to the following expression (2), the optimum training method selection unit 121 determines the training method θⱼ having the most similar task information to that of the edge device 110 within the range of the specification information s_{I}in which the specification information sⱼ necessary for the training method can be used, and sends the training method θⱼ to the edge device 110 side.

$$\begin{matrix}[ Mathematical Expression 2 ] & \\ arg {min}_{j} {z}_{I}^{T} {z}_{j} subject to {s}_{j} \leq {s}_{I} & ( 2 )\end{matrix}$$

Note that, although the server 120 and the edge device 110 correspond on a one-to-one basis in the example illustrated in FIG. 3, it should be understood that the learning system 300 is actually configured such that one server provides the same service to a plurality of edge devices.

### D. Cooperation Between Edge Devices

As described in the above-described section C, the learning system according to the present disclosure basically includes a server and an edge device. FIG. 5 schematically illustrates a functional configuration of a learning system 500. An edge device 501 outputs task information extracted from a training data set and specification information available for training. In contrast, a server 502 selects an optimum training method for task information of the edge device 501 within the range of the specification available for training by the edge device 501 on the basis of a meta-learning framework, and notifies the edge device 501 of the optimum training method. Therefore, the edge device 501 can efficiently train a model by using the data set collected by itself, on the basis of the optimum training method which the edge device 501 is notified of by the server 502.

In contrast, in the Internet of Things (IoT) society and the like, while a large number of edge devices are adjacent to each other and communication can be performed at low cost between the edge devices, there are problems such as communication delay that occurs because the edge device and the server are separated from each other, difficulty in connection due to heavy access from a large number of edge devices, and high communication cost between the edge device and the server.

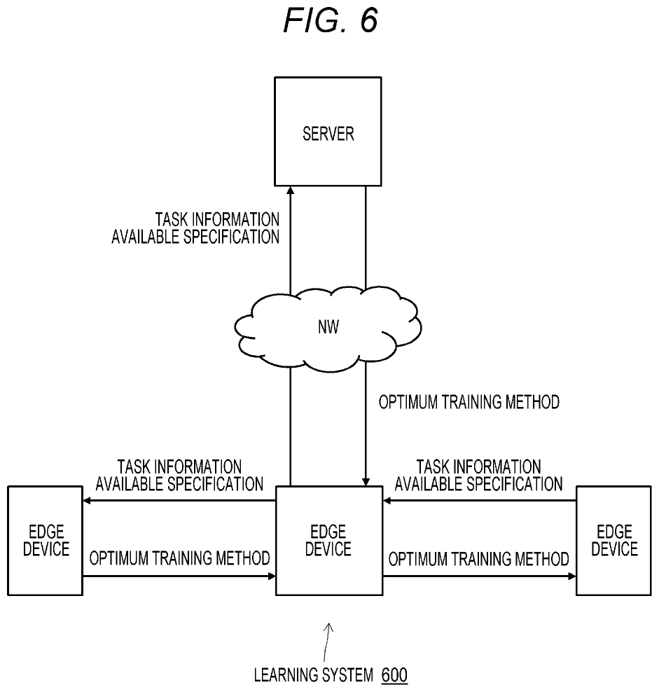

Therefore, in an environment where a plurality of edge devices exists in the periphery, as illustrated in FIG. 6, a learning system 600 using cooperation between the edge devices is configured. In the learning system 600, communication opportunities between the edge device and the server may be reduced by exchanging information regarding the optimum training method between the edge devices having similar task information and a similar available specification. Furthermore, in a case where there is no edge device having similar task information and a similar available specification in the periphery and the optimum training usage cannot be acquired from the peripheral edge device, the edge device may communicate with the server to acquire the optimum training method as illustrated in FIG. 5.

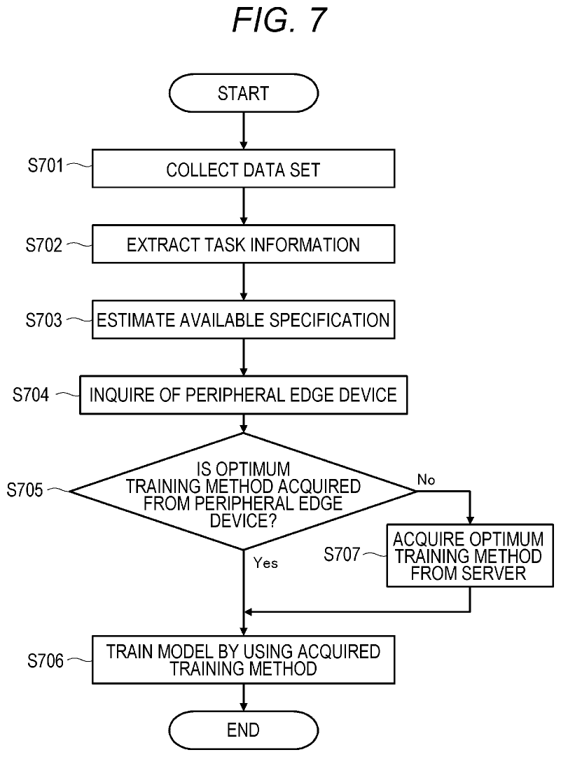

FIG. 7 illustrates a processing procedure for the edge device to perform model training in the learning system 600 illustrated in FIG. 6 in the form of a flowchart.

First, the edge device collects a data set used for model training (step S701). Then, the edge device extracts task information of the model to be trained from the collected data set on the basis of a framework of meta-learning (step S702). Furthermore, the edge device estimates a specification that can be used for model training (step S703).

Next, the edge device inquires of a peripheral edge device about task information and an available specification of the peripheral edge device itself (step S704). Here, in a case where an edge device having similar task information and a similar available specification exists in the periphery and an optimum training method can be acquired from the peripheral edge device (Yes in step S705), the edge device performs model training on the basis of the acquired training method (step S706).

In contrast, in a case where an edge device having task information and an available specification similar to those of the edge device does not exist in the periphery and an optimum training method cannot be acquired from the peripheral edge device (No in step S705), the edge device inquires of the server about the task information and the available specification of the edge device itself, acquires an optimum training method from the server (step S707), and performs model training on the basis of the acquired training method (step S706).

### E. Apparatus Configuration

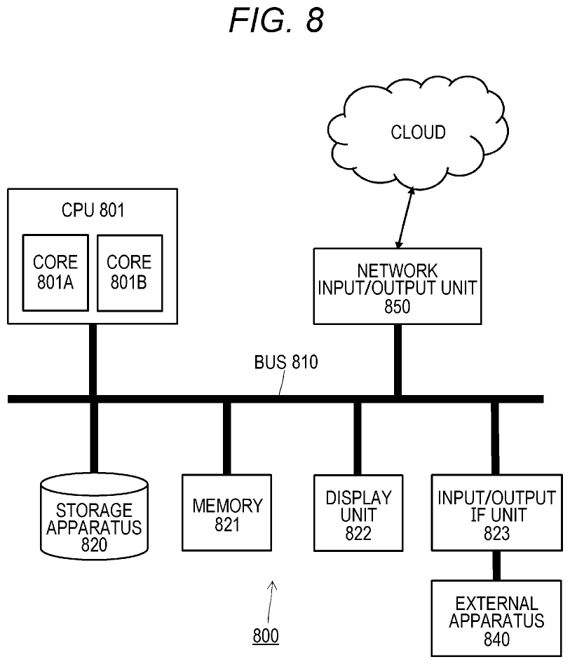

FIG. 8 schematically illustrates a configuration example of an information processing apparatus 800 that can operate as the server 120 in the learning systems 100 and 200.

The information processing apparatus 800 operates under the overall control of a central processing unit (CPU) 801. In the illustrated example, the CPU 801 has a multi-core configuration including a processor core 801A and a processor core 801B. The CPU 801 is interconnected with each component in the information processing apparatus 800 via a bus 810.

A storage apparatus 820 includes, for example, a large-capacity external storage apparatus such as a hard disk drive (HDD) or a solid state drive (SSD), and stores a program executed by the CPU 801 and a file of data used while the program is being executed or generated by executing the program. For example, the storage apparatus 820 is used as the training method database 122, and stores corresponding task information for each training method and information of specification information necessary for implementing each training method as illustrated in FIGS. 2 or 4. Furthermore, the storage apparatus 820 stores a program for the CPU 801 to calculate an optimum training method for the task information and the available specification.

The memory 821 includes a read only memory (ROM) and a random access memory (RAM). The ROM stores, for example, a startup program and a basic input/output program of the information processing apparatus 800. The RAM is used for loading a program to be executed by the CPU 801 and temporarily storing data used during execution of the program. For example, a program for calculating an optimum training method for task information and an available specification is loaded from the storage apparatus 820 into the RAM, and when either the processor core 801A or the processor core 801B executes the program, processing of calculating the optimum training method for the task information and the available specification is executed.

A display unit 822 includes, for example, a liquid crystal display or an organic electro luminescence (EL) display. The display unit 822 displays data during execution of the program by the CPU 801 and the execution result. For example, task information and available specification information received from the edge device, information regarding the calculated optimum training method, and the like are displayed on the display unit 822.

An input/output interface (IF) unit 823 is an interface apparatus for connecting various external apparatuses 840. The external apparatus 840 includes a keyboard, a mouse, a printer, an HDD, a display, and the like. The input interface unit 823 includes, for example, a connection port such as a universal serial bus (USB) or a high definition multimedia interface (HDMI) (registered trademark).

A network input/output unit 850 performs input/output processing between the information processing apparatus 800 and the cloud. The network input/output unit 850 inputs a data set from an edge device (not illustrated in FIG. 8) via the cloud, and outputs information of a reference data group of a higher ranking based on similarity between the input data set and each reference data set group to the edge device or an information terminal of the user of the edge device.

### INDUSTRIAL APPLICABILITY

The present disclosure has been described in detail above with reference to specific embodiments. However, it is obvious that those skilled in the art can make modifications and substitutions of the embodiments without departing from the gist of the present disclosure.

In the present Description, embodiments in which the present disclosure is applied to an edge device to perform user-specific model training specialized for the needs of each user have been mainly described; however, the gist of the technology disclosed in the present Description is not limited thereto. Some or all of the functions of the present disclosure may be constructed on the cloud or an operating apparatus capable of large-scale operation, or the present disclosure may be used to train a general-purpose model without being specialized for the needs of a specific user. Furthermore, the present disclosure can be applied to training of various types of models such as a neural network, support vector regression, and Gaussian process regression.

In short, the present disclosure has been described in the form of exemplification, and the contents described in the present Description should not be interpreted in a limited manner. In order to determine the gist of the present disclosure, the claims should be taken into consideration.

Note that the present disclosure can also be configured as follows.

(1) An information processing apparatus including:
a management unit that stores a correspondence relationship between a training method for a model and task information of the model; and
a selection unit that selects an optimum training method for task information input from a predetermined device and outputs the optimum training method to the device.

(2) The information processing apparatus according to the (1), in which the selection unit selects an optimum training method for task information that has been input on the basis of similarity of a feature vector representing task information.

(3) The information processing apparatus according to the (2), in which the feature vector is calculated from a training data set of a relevant model by using meta-learning.

(4) The information processing apparatus according to any one of the (1) to (3),
in which the management unit associates pieces of specification information necessary for implementing training methods with the training methods, respectively, and stores the pieces of specification information and the training methods and
the selection unit selects an optimum training method within a range of a specification available for training in the device.

(5) An information processing method including:
a management step of managing a correspondence relationship between a training method for a model and task information of the model in a database; and
a selection step of selecting, from the database, an optimum training method for task information input from a predetermined device and outputting the optimum training method to the device.

(6) A computer program described in a computer-readable format causing a computer to function as:
a management unit that stores a correspondence relationship between a training method for a model and task information of the model; and
a selection unit that selects an optimum training method for task information input from a predetermined device and outputs the optimum training method to the device.

(7) An information processing apparatus including:
a collection unit that collects a data set used for training a model;
an extraction unit that extracts task information of the model on the basis of the data set that has been collected;
an acquisition unit that acquires an optimum training method for the task information from an external apparatus; and
a training unit that trains the model by using the training method that has been acquired.

(8) The information processing apparatus according to the (7) further including an inference unit that performs inference by using a model trained by the training unit.

(9) The information processing apparatus according to the (7) or (8),
in which the extraction unit calculates a feature vector representing a data set that has been collected as task information by using meta-learning, and
the acquisition unit acquires an optimum training method selected on the basis of task information having a similar feature vector.

(10) The information processing apparatus according to any one of the (7) to (9) further including a specification information calculation unit that calculates a specification available for the training unit to train the model,
in which the acquisition unit acquires an optimum training method for the task information, the optimum training method being able to be implemented within a range of the specification available.

(11) An information processing method including:
a collection step of collecting a data set used for training a model;
an extraction step of extracting task information of the model on the basis of the data set that has been collected;
an acquisition step of acquiring an optimum training method for the task information from an external apparatus; and
a training step of training the model by using the training method that has been acquired.

(12) A computer program described in a computer-readable format causing a computer to function as:
a collection unit that collects a data set used for training a model;
an extraction unit that extracts task information of the model on the basis of the data set that has been collected;
an acquisition unit that acquires an optimum training method for the task information from an external apparatus; and
a training unit that trains the model by using the training method that has been acquired.

(13) A learning system including:
a first apparatus that collects a data set and trains a model; and
a second apparatus that outputs a training method for the model to the first apparatus;
in which the first apparatus extracts task information of the model on the basis of the data set that has been collected, and
the second apparatus selects an optimum training method for task information of the first apparatus by using a database that stores a correspondence relationship between a training method for a model and task information of the model, and outputs the optimum training method to the first apparatus.

### REFERENCE SIGNS LIST

100, 300 Learning system
110 Edge device
101 Data collection unit
102 Collected data accumulation unit
103 Data processing unit
104 Task information extraction unit
105 Training method reception unit
106 Training data set accumulation unit
107 Model training unit
108 Model parameter holding unit
109 Specification information calculation unit
111 Inference unit
112 Data input unit
113 Input data processing unit
121 Optimum training method selection unit
122 Training method database
800 Information processing apparatus
801 CPU
801A, 801B Processor core
810 Bus
820 Storage apparatus
821 Memory
822 Display unit
823 Input/output interface unit
840 Input/output apparatus
850 Network input/output unit

1. An information processing apparatus comprising:
a management unit that stores a correspondence relationship between a training method for a model and task information of the model; and
a selection unit that selects an optimum training method for task information input from a predetermined device and outputs the optimum training method to the device.

2. The information processing apparatus according to claim 1,
wherein the selection unit selects an optimum training method for task information that has been input, on a basis of similarity of a feature vector representing task information.

3. The information processing apparatus according to the claim 2,
wherein the feature vector is calculated from a training data set of a relevant model by using meta-learning.

4. The information processing apparatus according to claim 1,
wherein the management unit associates pieces of specification information necessary for implementing training methods with the training methods, respectively, and stores the pieces of specification information and the training methods and
the selection unit selects an optimum training method within a range of a specification available for training in the device.

5. An information processing method comprising:
a management step of managing a correspondence relationship between a training method for a model and task information of the model in a database; and
a selection step of selecting, from the database, an optimum training method for task information input from a predetermined device and outputting the optimum training method to the device.

6. A computer program described in a computer-readable format causing a computer to function as:
a management unit that stores a correspondence relationship between a training method for a model and task information of the model; and
a selection unit that selects an optimum training method for task information input from a predetermined device and outputs the optimum training method to the device.

7. An information processing apparatus comprising:
a collection unit that collects a data set used for training a model;
an extraction unit that extracts task information of the model on a basis of the data set that has been collected;
an acquisition unit that acquires an optimum training method for the task information from an external apparatus; and
a training unit that trains the model by using the training method that has been acquired.

8. The information processing apparatus according to claim 7, further comprising
an inference unit that performs inference by using a model trained by the training unit.

9. The information processing apparatus according to claim 7,
wherein the extraction unit calculates a feature vector representing a data set that has been collected as task information by using meta-learning, and
the acquisition unit acquires an optimum training method selected on a basis of task information having a similar feature vector.

10. The information processing apparatus according to claim 7, further comprising
a specification information calculation unit that calculates a specification available for the training unit to train the model,
wherein the acquisition unit acquires an optimum training method for the task information, the optimum training method being able to be implemented within a range of the specification available.

11. An information processing method comprising:
a collection step of collecting a data set used for training a model;
an extraction step of extracting task information of the model on a basis of the data set that has been collected;
an acquisition step of acquiring an optimum training method for the task information from an external apparatus; and
a training step of training the model by using the training method that has been acquired.

12. A computer program described in a computer-readable format causing a computer to function as:
a collection unit that collects a data set used for training a model;
an extraction unit that extracts task information of the model on a basis of the data set that has been collected;
an acquisition unit that acquires an optimum training method for the task information from an external apparatus; and
a training unit that trains the model by using the training method that has been acquired.

13. A learning system comprising:
a first apparatus that collects a data set and trains a model; and
a second apparatus that outputs a training method for the model to the first apparatus;
wherein the first apparatus extracts task information of the model on a basis of the data set that has been collected, and
the second apparatus selects an optimum training method for task information of the first apparatus by using a database that stores a correspondence relationship between a training method for a model and task information of the model, and outputs the optimum training method to the first apparatus.
